(19) United States
(12) Patent Application Publication
(10) Pub. No.: US 2018/0194561 A1
(43) Pub. Date: Jul. 12, 2018

(54) MATERIAL WITH AT LEAST TWO LAYER COVERINGS

(71) Applicant: SGL CARBON SE, Wiesbaden (DE)

(72) Inventors: Marcel REMP, Meitingen (DE); Tobias SCHMIDT, Meitingen (DE); Andreas WOEGINGER, Meitingen (DE); Florian GOJNY, Meitingen (DE)

(73) Assignee: SGL CARBON SE, Wiesbaden (DE)

(21) Appl. No.: 15/746,105

(22) PCT Filed: Jun. 16, 2016
(86) PCT No.: PCT/EP2016/063958

§ 371 Date: Jan. 19, 2018

(30) Foreign Application Priority Data
Jul. 20, 2015 (DE) 10 2015 213 568.3

(51) Int. Cl. B65G 15/34; F16G 1/10; F16G 1/16

(52) U.S. Cl. CPC B65G 15/34; F16G 1/16; F16G 1/10

(57) ABSTRACT

A material based on fibre-reinforced materials such as carbon-fibre reinforced plastics, prepegs, towpregs, with at least one locally pre-treated polymer covering. The covering has a hardness gradient, that is, from harder to softer from the inside to the surface of the covering.

The present invention relates to a material based on fibre-reinforced materials having a covering, which is suitable for producing load carriers in particular.

In order to increase the load-bearing capacity or to restore the original load-bearing capacity of buildings, it is known to retrospectively attach tension bodies, which are generally pretensioned, to the outside of said buildings. In addition to steel plates, fibre-reinforced plastics components, in particular carbon fibre-reinforced plastics, have also been used in recent years for this purpose.

Tension bodies are also often used in lift systems, cranes and vehicles and have a minimum degree of flexibility on the one hand and have to securely transmit static and dynamic loads on the other. In practice, flexible, deflectable tension bodies generally tend to be traction ropes or pull cables, whereby wires, as the main element, are often stranded to form strands.

“Load carriers” (carrier means) are generally understood by a person skilled in the art to mean covered components that are intended to transmit tensile forces in particular. The covering protects the carrier means against mechanical damage, whilst the encased core is used to transmit the prevailing tensile forces and to provide the carrier means with the necessary load-bearing capacity and impact strength.

WO 2009/026730 discloses a carrier means for a lift system, which comprises a plurality of fibrous metal tension elements, each of which is coated with a thermoplastic, a plurality of said coated tension elements being covered by an outer covering consisting of a polymer material.

WO 2009/090299 discloses a carrier means, which is formed as a tension member covered with a polymer layer. The tension member is a fibre composite material formed of fibres impregnated with a polymer matrix.

EP 1 109 072 discloses belts formed by pultrusion, which are produced by first fibres being drawn from a spool and being drawn through an elastomer in order to impregnate the fibres, subsequently wound around a die and lastly cured in a pultrusion method.

EP 1452770 discloses a method for constructing a belt, according to which an elastomer layer is first placed on a build mandrel, followed by a cross-cord layer, followed by a second elastomer layer, after which a tension element is placed on top of the second elastomer layer and a third elastomer layer is lastly applied to said tension element.

EP 1498542 discloses a tension body, which can move in its longitudinal axis around at least one deflection roller. Said body comprises a wire bundle that is embedded in a core made of a plastics material cover.

DE 10 2011 005 323 discloses a tension member covered with a polymer layer, which can be produced according to a method in which a tension member is first produced by impregnating at least one fibrous structure containing carbon fibres with a curable resin and then pultruding the fibrous structure thus obtained, and then covering at least regions of the tension member produced in this way with a polymer layer by means of extrusion.

The load carriers or support means, which comprise a covering and are known in the art are, however, still not completely satisfactory in terms of all their properties, and therefore there is a need to develop and provide materials from which load carriers or carrier means having improved properties can be made.

The object of the present invention was therefore to provide materials, in particular for producing load carriers, which lead to products having improved product properties.

According to the invention, this object is achieved by the materials according to claim 1.

Preferred embodiments of the present invention can be found in the dependent claims and in the following description.

The materials according to the invention are based on a fibrous structure comprising a polymer-based covering, which is provided at least in regions and comprises at least two layers, the Shore hardness of the outermost layer differing from the adjoining adjacent layer, the outermost layer having a lower Shore hardness than the adjoining adjacent layer.

The materials according to the invention comprise a core based on a fibrous structure.

Within the context of the present invention, a “fibrous structure” is intended to mean any structure comprising one or more fibres.

According to a preferred embodiment of the present invention, a roving, a laid scrim, a nonwoven, a warp-knitted fabric, a weft-knitted fabric, a braided fabric, one or more yarns, one or more strands or a woven fabric is/are used as the fibrous structure.

“Woven fabrics” are generally understood to mean flat textile fabrics consisting of at least two fibre systems, which cross at right angles, the warp running in the longitudinal direction and the weft running perpendicularly thereto.

“Warp-knitted fabrics” are generally understood to mean textile products that are produced by means of loop formation.

Laid fibre scrims are a processing variant of fibres, in which the fibres are not woven but are oriented in parallel with one another and embedded in a chemical carrier substance (the matrix), and are generally fixed from above and below by means of cover films and optionally by means of a quilting thread or an adhesive. As a result of the parallel orientation of the fibres, laid fibre scrims have a pronounced anisotropy of the strengths in the orientation direction and perpendicularly thereto.

A nonwoven consists of loose closely lying fibres that have not yet been interconnected. The strength of a nonwoven only relates to the fibre-intrinsic adhesion, but can be influenced by reprocessing. In order to be able to process and use the nonwoven, said nonwoven is generally reinforced using various methods.

Nonwovens are different to woven fabrics or warp-knitted fabrics, which are characterised by the individual fibres or threads being laid in a manner determined by the production method. In contrast, nonwovens consist of fibres whose position can only be described using statistical methods. The fibres are tangled together in the nonwoven. The English term “nonwoven” accordingly clearly distinguishes them from woven fabrics. Nonwovens are distinguished by the fibre material (e.g. the polymer in chemical fibres), the bonding method, the type of fibres (staple fibres or continuous fibres), the fibre fineness and the fibre orientation, inter alia. In this case, the fibres can be laid so as to be defined in a preferred direction or can be oriented completely stochastically, as in random orientation nonwovens.

If the fibres do not have a preferred direction in terms of their orientation, said nonwoven is an isotropic nonwoven. If the fibres are more frequently arranged in one direction than in another direction, this is referred to as anisotropy.

Within the context of the present invention, felts are also intended to be understood as the fibrous structure. A felt is a textile fabric consisting of irregularly arranged fibrous material that is difficult to separate. In principle, felts are therefore not woven textiles. Felts are generally produced from chemical fibres and plant fibres by dry needling (needle felts) or by being reinforced using water jets leaving a nozzle bar under high pressure. The individual fibres in the felt are randomly intertwined.

Like nonwovens, felts can be produced from practically any natural or synthetic fibres. As well as needling, or in addition, it is also possible to interlock the fibres using a pulsed water jet or a binding agent. These methods are suitable in particular for fibres that do not have a scaly structure, such as polyester or polyamide fibres.

Felts have good temperature resistance and are generally moisture-repellent, which can be advantageous when used in fluid-carrying systems in particular.

“Braided fabric” refers to a product that can be produced by interlooping a plurality of strands of flexible material.

“Yarns” are generally understood to mean long, thin structures consisting of one or more fibres. Yarns are intermediate textile products, which can be processed to form woven fabrics, warp-knitted fabrics and weft-knitted fabrics.

Any natural and synthetic fibres can in principle be used as the fibres in the fibrous structure of the materials according to the invention. Carbon fibres, glass fibres, polymer fibres such as aramid fibres, basalt fibres or cotton fibres should be mentioned here, but only by way of example. For each specific application, a person skilled in the art will select the suitable fibres for the intended use.

In some cases, it has proven advantageous for at least some of the fibres in the fibrous structure to be carbon fibres, which can be used, for example, as a roving containing carbon fibres, as a leno fabric containing carbon fibres or as a woven tape containing carbon fibres.

In this case, in the context of the present invention, a “roving” is intended to mean a bundle, strand or multifilament yarn made of filaments (continuous fibres) arranged in parallel.

Rovings containing carbon fibres and having a filament count in the range of from 1000 to 300,000, preferably in the range of from 12,000 to 60,000 and in particular in the range of from 24,000 to 50,000 are particularly suitable for producing the materials according to the invention.

In some cases, it has proven advantageous for a carbon fibre-containing fibrous structure in the form of a roving to be used, the fibres of which have a weight per length in the range of from 1 to 20 g/m, preferably in the range of from 2 to 10 g/m and particularly preferably in the range of from 3 to 7 g/m. In composite materials, a fibrous structure containing such fibres can be used to provide a particularly effective amount of adhesion between the fibres and the impregnated polymer and therefore a particularly strong bond in a load carrier produced from a material according to the invention.

Carbon fibre-containing fibrous structures in the form of a roving, the fibres of which have a diameter in the range of from 2 to 20 μm, and particularly preferably between 5 and 12 μm, have proven to be advantageous in some cases. Load carriers based on such fibrous structures are also characterised by a particularly effective bond between the fibrous structure and the impregnating polymer.

Preferred fibrous structures have a carbon fibre content of at least 50%, particularly preferably at least 80%, particularly preferably at least 90% and most preferably the fibre content of the fibrous structure consists of only carbon fibres. In fibrous structures that do not only consist of carbon fibres, the remaining fibre content can consist of glass fibres, polymer fibres such as aramid fibres, basalt fibres or any mixtures of two or more of the above-mentioned types of fibres, for example.

In principle, the fibres in the fibrous structure can be oriented in any conceivable manner. In many cases, however, it has proven advantageous to use fibrous structures in which at least some of the fibres are oriented in parallel and with a specific fibre direction. At least 50%, preferably at least 80% and particularly preferably at least 90% of the fibres are substantially oriented in one direction. In this context, “substantially” means that the longitudinal axes of the fibres deviate from the ideal parallelism by less than 10%. Unidirectional laid scrims, woven fabrics, warp-knitted fabrics, weft-knitted fabrics and braided fabrics are particularly preferred. In a laid scrim, the fibre direction is defined by the longitudinal axis of the fibres, whereas in woven fabrics, warp-knitted fabrics, weft-knitted fabrics and braided fabrics the fibre direction is defined along a preferred longitudinal axis, for example by the direction of the warp thread in a woven fabric.

The fibrous structure can also consist of a plurality of layers, which can be wound successively, for example. In this regard, the fibrous structure is not particularly restricted. When impregnated fibrous structures are used, it has proven advantageous in some cases to produce multilayer materials by winding a plurality of layers of impregnated fibrous structures one after the other. Suitable methods are known to a person skilled in the art and are described in the literature, and so details have been spared here.

For some intended uses, it has proven advantageous for multilayer fibrous structures to be used, in which the fibres are oriented differently in the individual layers. In this way, the anisotropy of the properties of load carriers made from the materials according to the invention can be adjusted and reduced. This is, however, generally at the detriment of the achievable tensile strengths. A person skilled in the art will decide whether to use oriented, in particular unidirectional, or isotropic fibrous structures for the specific intended use. Oriented and in particular unidirectional fibrous structures can, as mentioned, generally absorb and transmit greater maximum forces in the direction in which the fibres are oriented than isotropic materials, which is why oriented and in particular unidirectional fibrous structures are preferred.

In order to produce fibre-reinforced composite materials, the fibrous structures are advantageously embedded in a matrix made of a resin that is then polymerised or cured.

For this purpose, the fibrous structure is preferably impregnated with at least one polymer precursor.

According to the invention, in particular reactive thermoplastic precursors and reactive thermosetting precursors are suitable as the polymer precursor. In this case, a reactive thermoplastic precursor refers to a polymer precursor, which can be polymerised to form a thermoplastic, whereas a reactive thermosetting precursor refers to a polymer precursor that can be polymerised and crosslinked to form a thermoset by means of curing. The thermoplastic or thermosetting precursor is preferably polymerised or cured by means of heat-treatment in this case, it being possible to admix a catalyst to the thermoplastic or thermosetting precursor for this purpose. A thermoplastic or thermosetting precursor has a comparatively low viscosity compared with the polymer in the form of the end product, and can therefore penetrate particularly deep into the fibrous structure and uniformly impregnate said structure to a particularly great extent.

Reactive thermoplastic precursors and reactive thermosetting precursors are suitable in particular as polymer precursors. In this case, “reactive thermoplastic polymer precursors” are understood to mean monomeric or oligomeric polymer precursors, which produce a thermoplastic polymer as the end product following polymerisation.

Thermosetting polymer precursors produce thermosetting polymers following polymerisation.

Thermoplastic polymers or thermoplastics can be reversibly deformed by melting in a specific temperature range below its decomposition temperature. Thermoplastics comprise reversibly separable weak bonds between individual polymer chains, which can be reversibly separated by inputting energy. Thermoplastics can be produced, either directly or with the assistance of catalysts, according to polymerisation methods known to a person skilled in the art, such as radical polymerisation, addition polymerisation or condensation polymerisation. Corresponding methods are known to a person skilled in the art and are described in the literature.

Unlike thermoplastics, thermosetting polymers, often also referred to as thermosets or thermosetting plastics, cannot deform any more following polymerisation and curing, since they are three-dimensionally crosslinked by means of covalent bonds. Methods for producing thermosetting plastics are also known to a person skilled in the art and are described in the literature.

When using thermoplastic or thermosetting precursors, these are preferably thermally transformed into the corresponding polymers once they have been applied to the fibre-reinforced material. Suitable catalysts can be added to speed up the reaction or to be able to use lower reaction temperatures.

Polymer precursors have a lower viscosity than the polymeric end products, which can be advantageous for the complete impregnation of the fibrous structure intended to be covered.

Examples of reactive thermoplastic precursors that can be used for producing the materials according to the invention are mixtures of monomers and optionally catalysts, mixtures of oligomers and optionally catalysts or mixtures that contain monomers, oligomers and optionally catalysts.

Within the context of the present invention, “oligomers” are understood to mean products that comprise at least 2 and fewer than 100 recurring units. In contrast, polymers within the context of the present invention are intended to comprise more than 100 recurring units (repeat units).

As already mentioned, the temperature at which the desired polymerisation is achieved, and therefore the course of polymerisation, can be controlled by using a catalyst.

Preferred thermoplastic polymers for the materials according to the invention are thermoplastic polyurethane, polyamide, polyester, natural and synthetic rubbers or elastomers. “Elastomers” are in this case understood to mean dimensionally stable but elastically deformable plastics materials, the glass transition temperature of which is below the use temperature. Such plastics can elastically deform when subjected to tension or pressure, but then return to their original undeformed shape.

The corresponding monomers that can be transformed into the desired polymers are used as thermoplastic precursors, and a person skilled in the art will select the suitable polymer for the specific case on the basis of his expert knowledge. Examples are caprolactam, which provides a polymer also known as polyamide-6, or mixtures of adipic acid and hexamethylenediamine, which provide a polymer known as polyamide-66.

Examples of reactive thermosetting precursors, which can be cured to form thermosetting plastics, are phenolic resins, polyurethane oligomers, epoxy resins and unsaturated polyester resins, which provide the corresponding thermosetting plastics after curing.

In general, at least one of the monomers or oligomers of thermosetting precursors contains a functionality of more than two in order to achieve three-dimensional crosslinking.

Mixtures of the corresponding monomers, optionally mixed with oligomers and optionally catalysts or mixtures of oligomers and catalysts, can also be used in the case of thermosetting precursors.

Phenol formaldehyde resins are thermosetting plastics materials based on phenolic resin produced by polycondensation, and therefore mixtures of a phenol, an aldehyde and an acid or base, for example, as reactive thermosetting precursors, are suitable as the catalyst. The known phenol formaldehyde resins should be mentioned by way of example here.

Polyurethanes may be given as an additional group of thermosetting plastics that are suitable as the material for impregnating the fibrous structure. Polyurethanes are crosslinked polymers, which contain urethane groups that can be synthesised from polyols and polyisocyanates by means of a polyaddition reaction. Amines or metalorganic compounds can be used as the catalysts. Suitable products are known to a person skilled in the art and are described in the literature.

Epoxy resins represent an additional group of suitable thermosetting precursors. They can be produced by reacting epoxides with diols, for example. The reaction of epichlorohydrin with a diol such as Bisphenol A and a catalyst should be given as an example here.

Thermosetting polyesters can be produced by polycondensing acids and alcohols, at least one of the monomers having three or more functions.

The fibrous structure can either be impregnated by impregnating individual fibres of filaments or the fibrous structure can be guided through a dipping bath, for example, and impregnated with the curable resin. Corresponding methods for impregnating fibrous structures are known to a person skilled in the art and are described in the literature, and so details will be spared here.

Prepregs and in particular towpregs are preferably used as the impregnated fibrous structures.

“Prepreg” is understood by a person skilled in the art to mean semifinished products consisting of fibres and a thermosetting plastics matrix. The fibres can be in the form of directed or undirected continuous fibres, or can be in the form of shorter fibre snippets in bulk or sheet moulding compounds (BMC or SMC). In the narrower sense, prepregs contain continuous fibres and are preferred within the context of the present invention.

Prepregs can be produced by guiding a finished structure comprising fibres through a dipping bath, for example, which contains a resin suitable for impregnating said structure.

Towpregs are produced by the structure being impregnated with a matrix resin before the final two-dimensional or three-dimensional fibrous structure is provided. This can lead to more effective impregnation and towpregs are therefore used as the fibrous structures in a preferred embodiment of the present invention.

In order to improve the adhesion between the fibrous structure and the impregnating resin, the fibres of the fibrous structure can be provided with a sizing agent. Suitable products are known per se and are described in the literature, and so additional embodiments are not necessary here.

The material according to the invention comprises a polymer-based covering, which is provided at least in regions and consists of at least two layers, the Shore hardness of the outermost layer differing from the adjoining adjacent layer and the outmost layer having a lower Shore hardness than the adjoining adjacent layer. In this case, the covering preferably comprises two or more defined layers, which can be distinguished from one another, for example by coating materials applied one after the other and having different Shore hardnesses. However, it is also possible for the covering to consist of layers that cannot be distinguished from one another, for example by applying just one coating material which has, as the finished covering, a hardness gradient, and for the Shore hardness to decrease from the inside out. In this embodiment, the covering thus comprises an endless number of infinitesimal small layers of different hardnesses, which can no longer be considered as distinguishable from one another and defined in this sense. However, it is preferable for the respective layers to be distinguishable from one another and therefore for them not to be infinitesimally small.

The Shore hardness as a parameter is directly related to the penetration depth of an indenter positioned on the surface of the corresponding workpiece. A distinction is made between the Shore hardnesses A, C and D. In order to determine the Shore A hardness, a truncated cone having an end face of 0.79 mm in diameter and an opening angle of 35° is used as the indenter. When determining the Shore D hardness, the diameter of the truncated cone is 0.1 mm and the opening angle is 30°.

Within the context of the present invention, “adjoining adjacent layer” can be understood to mean the layer of the at least double-layered covering, which layer directly adjoins the inside of the outermost layer.

The polymer covering of the materials according to the present invention can also consist of more than two layers, which cover the optionally impregnated fibrous structure that forms the basis of the materials according to the invention. The optionally provided additional layers can differ from the outermost layer and from the layer directly adjoining the inside of said outermost layer or can substantially correspond to this layer. In any case, however, there needs to be a difference between the Shore hardness of the outermost layer and of the layer directly adjoining the inside thereof, the outermost layer having a lower Shore hardness than the adjoining adjacent layer.

A person skilled in the art can influence and set this difference in hardness by selecting suitable materials for the corresponding layers of the covering or by controlling the polymerisation process.

The Shore D hardness of the adjacent layer of the covering, which layer adjoins the outermost layer, is preferably in the range of from 30-70, preferably from 30-60 and particularly preferably in the range of from 35-50 (measured at a temperature of 23° C. in each case).

The Shore A hardness of the outermost layer is preferably in the range of from 50-90, particularly preferably in the range of from 55-90 and most preferably in the range of from 70-90 (measured at a temperature of 23° C.).

According to a preferred embodiment of the present invention, the total thickness of the at least two layers is in the range of from 0.1-30 mm, preferably from 0.2-20 mm and the total thickness is particularly preferably in the range of from 0.3-15 mm.

In this case, the adjacent layer adjoining the outermost layer preferably has a thickness in the range of from 0.05-5 mm, particularly preferably from 0.1-2 mm and in particular from 0.2-0.5 mm.

The thickness of the outermost layer is preferably in the range of from 0.1-10 mm, in particular in the range of from 0.3-2 mm and particularly preferably in the range of from 0.4-0.8 mm.

The covering of the materials according to the invention is preferably based on thermoplastic polymers.

Thermoplastic polymers, which can be extruded, wound or applied using other conventional chemical or physical methods known to a person skilled in the art are preferably suitable as the polymers for the covering.

As described above, it is also possible to cover the preimpregnated fibrous structure with a polymer precursor in order to apply the covering, which is then polymerised or cured (generally at least partially before applying the covering).

A first group of preferred polymers for the covering are thermoplastic materials such as polyethylene, polypropylene, polystyrene, polyamide, polyester or thermoplastic polyurethane. Polytetrafluoroethylene (PTFE) can also be mentioned here.

Preferred plastics materials for the covering also include thermoplastic elastomers, based on polyurethane, polyamide and/or polyester, and natural and synthetic rubbers or elastomers.

If the materials according to the invention are exposed to high ambient temperatures during their intended use, high-temperature-resistant thermoplastic polymers, which are known to a person skilled in the art and are commercially available from several suppliers, can also be used for the covering.

In this case, polysulfones, polyethersulfones, polyimides, polyphenylene ethers and polyether ketones can be mentioned, but only by way of example.

In principle, it is also possible to use thermosetting polymer precursors for the at least double-layered covering. The products mentioned above for impregnating the fibrous structure are suitable thermosetting precursors. However, thermoplastic polymers are preferred as the material for the covering.

The optionally preimpregnated fibrous structure can be covered according to various methods that are known in principle to a person skilled in the art and are described in the literature.

A preferred method for producing the covering is extrusion.

In principle, any polymer can be used in this case, provided it can be extruded.

According to the invention, at least regions of the material are preferably covered by a polymer after impregnation of the fibrous structure and after at least partial curing or polymerisation of the impregnating resin.

According to an advantageous embodiment of the present invention, a polymer selected from the group consisting of thermoplastic polyolefins, thermoplastic polyurethanes, thermoplastic starches, thermoplastic rubbers, elastomeric rubbers, phenolic resins, polyurethane resins, epoxy resins, polyester resins, vinyl ester resins and any mixtures of two or more of said polymers is used for covering said fibrous structure.

In some cases, it has proven advantageous to use a polymer that has a modulus of elasticity of no more than 1000 MPa at room temperature for at least one layer of the covering.

The successive layers of the at least double-layered covering can be applied by successive extrusion processes, in which each layer can be applied in an extrusion process. Alternatively, it is also possible to form a double-layered or multilayered covering in one extrusion step by means of coextrusion using a suitable device. Suitable methods are described in the literature and are known per se to a person skilled in the art, and so details have been spared here. In this case, reference should be made to DE 10 2011 005 323 as one example.

In principle, the covering can be applied by means of extrusion at any suitable temperature, the polymer being heated during extrusion to a temperature of between 100° C. and 400° C., preferably between 150° C. and 300° C. and particularly preferably between 180° C. and 250° C., for example. As a result, conventional thermoplastics and thermoplastic elastomers produce an extrudate that has good flowability and good adhesion properties; as a result, the material is uniformly covered and a very strong integral bond is formed between the covering and the optionally preimpregnated fibrous structure.

In order to apply the polymer material to the optionally impregnated fibrous structure in a particularly controlled manner during extrusion and in particular to allow for accurate control of the thickness of the polymer layer applied, the polymer can preferably be extruded onto the impregnated material substantially perpendicularly to the orientation of the fibres in the fibrous structure. An extrusion nozzle can be used to extrude the polymer in this case, the outlet opening of which is oriented thereon substantially perpendicularly to the longitudinal direction of the impregnated material.

Before applying the covering, the resin in the preimpregnated fibrous structure is generally at least partially or completely cured.

In some cases, it has proven advantageous not to fully cure the impregnating polymer in the fibrous structure before applying the covering. Full curing then takes place while applying the covering, and the groups of the matrix resin in the fibrous structure, which structure has not yet been polymerised, can then interact with the polymers used for the covering, which can improve the bond between the covering and the matrix.

Instead of applying the covering by means of extrusion, it is also possible to cover the fibrous structure retrospectively, preferably by means of casting around the covering with a suitable plastics material, such as a reactive polyurethane elastomer.

Another alternative method for producing the covering consists in shrink-wrapping using a plastics tube. The tube is pulled over the optionally preimpregnated fibrous structure and heated in this case. By heating said tube, the plastics material of the tube contracts and thus rigidly surrounds the fibrous structure. The plastics materials suitable for the shrink-wrapping technique are known to a person skilled in the art and the choice of plastics materials is not particularly limited.

The layers of the covering, of which there are a plurality according to the invention, can be made of the same or different polymers. It is only essential for the outermost layer to have a lower Shore hardness than the adjoining adjacent layer.

The covering of the materials according to the invention not only provides protection against environmental influences, such as solar radiation, “acid” rain or wind carrying dust, but also makes it easier to handle load carriers made from the materials. Load carriers that do not comprise such a covering at the edge are sensitive, in particular to impact, which requires greater care when transporting and installing the material or load carrier. The covering prevents a decrease in strength or at least reduces the extent to which the strength is decreased as a result of edge damage.

Another advantage of this embodiment consists in the possibility of using more cost-effective matrix systems for impregnating the fibrous structure, such as resin systems that are not alkali-resistant. If there is no covering, alkali-resistant resin systems generally have to be used, since the carrying structure of the load carrier is directly exposed to external influences. As a result of a covering according to the present invention, it is no longer necessary, or is only necessary to a lesser extent, to provide the resin system of the matrix of the fibrous structure with additives or foreign matter that protect it against environmental influences.

Furthermore, it was surprisingly found that an at least double-layered covering comprising at least two layers having different Shore hardnesses leads to an increase in the strength of load carriers made of the materials according to the invention. This means that not only the strength of the plastics material of the covering is included when considering overall strength, but that the overall strength is considerably higher than the sum of the individual strengths. An essential parameter for this is the translation factor. The translation factor describes what proportion of the theoretical fibre tenacity is transferred. For a theoretical breaking force of 100 kN, for example, and a measured breaking force of 80 kN, the translation factor is 80%. In comparative measurements of load carriers having the same structure, one of which comprises a covering according to the invention and the other of which does not, there was a clear increase in the translation factor for the load carriers made of the materials according to the invention.

A covering that is fireproof, and in particular meets the fire-protection standard UL94 with a rating of V-0 is particularly preferable. For this purpose, in order to meet valid national and international fire-protection guidelines, the matrix material often has to contain a high proportion of flame retardant, i.e. a foreign body; this high foreign body proportion reduces the strength of the impregnated fibrous structure and therefore the strength of load carriers that can be made of the materials according to the invention, and also leads to problems regarding the production process. By using a covering according to the present invention, the proportion of flame retardant in the impregnating resin of the fibrous structure or of the anchoring portion can be reduced, thus simultaneously also improving the mechanical properties of the matrix material.

In some cases it has proven advantageous to increase the surface roughness of the impregnated fibrous structure before the covering is applied, and to therefore provide more anchoring points for the covering.

Roughness is a term from the field of surface physics, which denotes the unevenness of a surface. There are different calculation methods and measurement methods for quantitative characterisation. On average, an increase in the roughness leads to a greater difference between raised portions and depressions in the surface. The roughness of a surface can be modified by polishing, grinding, lapping, honing, mordanting, sandblasting, etching, coating or similar methods, inter alia. Without being tied to a specific theory, it is assumed that an increase in the roughness can increase the number of bonding sites between the fibrous structure and the covering and can therefore lead to improved bonding.

The advantages of the materials according to the invention comprising the covering that is provided at least in regions and consists of at least two layers lead, in load carriers made of the materials, to an improved application of power due to the distribution of the stress peaks over a larger surface area and less damage by small particles, since these effectively sink into the softer outer layer of the covering and can therefore no longer negatively affect the load carrier since the structure thereof remains intact in the load-bearing core. A notch effect caused by such particles, which carries the risk of failure of the load carrier, is avoided or at least considerably reduced.

Another advantage can be considered that of using the outer layer of the covering as a wear indicator for the early detection of changes that could lead to failure of the load carrier.

The materials according to the invention are suitable for producing load carriers in particular as a result of their properties.

The load carriers that can be produced in this way and are made of a material according to the invention can be used as carrier means in a load application, preferably in a conveyor, a transportation system, a tension system or a device for transmitting tension or power, in particular in a lift system.

The invention correspondingly also relates to conveyor belts, transport belts, tension transmission belts or power transmission belts, containing a portion having a load carrier made of a material according to the present invention.

The materials according to the invention are also suitable for producing reinforcement systems, which can be used in various fields of the building and construction industry, such as for increasing the load-bearing capacity of buildings, in particular for retrospectively increasing the load-bearing capacity of buildings, or for restoring the original load-bearing capacity of buildings as part of renovation work. One example application is the use of such a reinforcement system as a tension device for bridges.

1-10 (canceled)

11. A material based on a fibrous structure that comprises a polymer-based covering, which is provided at least in regions and comprises at least two layers, wherein the Shore hardness of the outermost layer differs from that of the adjoining adjacent layer and the outermost layer has a lower Shore hardness than the adjoining adjacent layer.

12. The material according to claim 11, wherein the Shore D hardness of the adjoining adjacent layer is in the range of from 30-70, preferably from 30 to 60 and particularly preferably from 35 to 50 at a temperature of 23° C.

13. The material according to claim 11, wherein the Shore A hardness of the outermost layer is in the range of from 50-90, preferably from 55 to 90 and particularly preferably from 70 to 90 at a temperature of 23° C.

14. The material according to claim 11, wherein the total thickness of all the layers of the covering is in the range of from 0.1 to 30 mm, preferably in the range of from 0.2 to 20 mm and particularly preferably in the range of from 0.3 to 15 mm.

15. The material according to claim 11, wherein the adjoining adjacent layer has a thickness in the range of from 0.05 to 5, preferably from 0.1 to 2 and particularly preferably from 0.2 to 1.0 mm.

16. The material according to claim 11, wherein the outermost layer has a thickness in the range of from 0.1 to 10, preferably from 0.3 to 2 and particularly preferably from 0.4 to 0.8 mm.

17. The material according to claim 11, which contains a towpreg as the fibrous structure.

18. A use of a material according to claim 11 for producing a load carrier.

19. A use of a load carrier made of a material according to claim 11 as a carrier means in a load application, preferably in a conveyor, a transportation system, a tension system or a device for transmitting tension or power, in particular in a lift system.

20. A conveyor belt, transport belt, tension transmission belt or power transmission belt, containing a portion having a load carrier made of a material according to claim 11.
